(19) United States
(12) Patent Application Publication
(10) Pub. No.: US 2020/0262678 A1
(43) Pub. Date: Aug. 20, 2020

(54) PASSENGER CONVEYING SYSTEM COMPRISING MONITORING DEVICE

(71) Applicant: thyssenkrupp Elevator Innovation and Operations AG, Essen (DE)

(72) Inventor: Wan-Khy CHOU, Stuttgart (DE)

(73) Assignee: thyssenkrupp Elevator Innovation and Operations AG, Essen (DE)

(21) Appl. No.: 16/758,521

(22) PCT Filed: Oct. 26, 2018
(86) PCT No.: PCT/EP2018/079376

§ 371 Date: Apr. 23, 2020

(30) Foreign Application Priority Data
Nov. 7, 2017 (DE) 10 2017 219 744.7

(51) Int. Cl. B66B 1/24; B66B 9/00

(52) U.S. Cl. CPC B66B 1/24; B66B 9/003; B66B 1/2491; B66B 2201/405; B66B 2201/103; B66B 2201/4676; B66B 1/2466

(57) ABSTRACT

A method can be used to operate an elevator system that comprises multiple elevator shafts, an elevator car, and a shaft changing unit. The elevator car can change from a first elevator shaft into a second elevator shaft by way of the shaft changing unit. To convey a user of the elevator system from a starting position to a destination position, a route is determined from a plurality of route options whereby initial values are taken into account for the determination of the route. In this context, a specification relating to use of the shaft changing unit is taken into account as an initial value from the initial values for the determination of the route.

The invention relates to a method for operating an elevator system, comprising a plurality of elevator shafts, at least one elevator car and at least one shaft-changing unit, wherein the at least one elevator car can be changed from a first elevator shaft to a second elevator shaft by means of the at least shaft-changing unit. In this context, in order to convey a user of the elevator system from a starting position to a destination position a route is determined from a plurality of route options, and a plurality of initial values are taken into account for the determination of the route. Furthermore, the invention relates to an elevator system which is designed to carry out such a method.

Elevator systems which have a plurality of elevator shafts and a plurality of elevator cars are sufficiently known in the prior art. In particular, what are referred to as multi-car elevator systems are known in which a plurality of elevator cars can be moved essentially independently of one another. In this context, the elevator cars can be moved from one elevator shaft into another elevator shaft using shaft-changing units, in particular by means of what are referred to as exchangers. Furthermore, by using a shaft-changing unit it is also possible to implement a change in the direction of travel in that, for example, the direction of travel of an elevator car changes from the vertical into the horizontal, or vice versa.

It is problematic here that elevator users of conventional elevator systems which provide only a vertical movement are not accustomed to the fact that the elevator can change its direction of movement. In order to overcome this problem, DE 10 2014 117 373 A1 discloses a signal generator which indicates to the user of an elevator car a change of shaft in which an elevator car changes from a vertical direction of travel to a horizontal direction of travel, or vice versa. In this context, when there is an imminent change of shaft the signal generator emits visual and/or acoustic signals, wherein a visual signal can indicate the new direction of travel, e.g. by means of an illuminated arrow in the elevator car. The provision of such signal generators in an elevator system as mentioned at the beginning enables a user to adapt to an imminent change of shaft.

However, such a change of shaft can nevertheless be felt to be unpleasant by a user of the elevator system. For example, sounds which occur in conjunction with the use of a shaft-changing unit and which are not familiar to the user from conventional elevator systems, for example sounds caused by the rotational movement of an exchanger, are therefore felt to be unpleasant by the user of the elevator. Furthermore, a horizontal movement of the elevator car can also be felt as such to be unpleasant.

Against this background, an object of the present invention is to improve a method mentioned at the beginning for operating an elevator system as well as to make available an improved elevator system. In particular, the intention here is to increase the acceptance of use of the user for such an elevator system and to improve the comfort of use.

In order to achieve this object, a method for operating an elevator system and an elevator system according to the independent claims are proposed. Further advantageous refinements of the invention are described in the dependent claims and in the description, and illustrated in the exemplary embodiments shown in the figures.

The proposed solution provides a method for operating an elevator system, comprising a plurality of elevator shafts, at least one elevator car and at least one shaft-changing unit, wherein the at least one elevator car can be changed from a first elevator shaft to a second elevator shaft by means of the at least shaft-changing unit. In order to convey a user of the elevator system from a starting position to a destination position a route is determined from a plurality of route options, and a plurality of initial values are taken into account for the determination of the route, wherein a specification relating to a use of the at least one shaft-changing unit is taken into account as an initial value from the plurality of initial values for the determination of the route.

In particular there is provision that a plurality of elevator cars can be moved individually, that is to say essentially independently of one another, in the elevator shafts. In this context, the elevator cars are preferably moved in the elevator shafts by means of a linear motor drive. In addition, there is, in particular, provision that the elevator system comprises vertically oriented elevator shafts in which the elevator cars can be moved vertically. Furthermore, there is, in particular, provision that the elevator system comprises horizontally oriented elevator shafts in which the elevator cars are moved horizontally. Furthermore, the elevator system can, in particular, also comprise diagonally oriented elevator shafts in which the elevator cars are moved obliquely.

In this context, an elevator car of the elevator system changes from one elevator shaft to another elevator shaft by means of a shaft-changing unit. In this context, in particular an exchanger is provided as a shaft-changing unit. Such an exchanger is described, for example, in JP 06048672 A.

In order to convey a user from a starting position, in particular from a starting floor, to a destination position, in particular to a destination floor, there is, in particular, provision that the user firstly makes a corresponding call. The elevator system here preferably has a destination call controller by means of which the user outside the elevator car inputs the destination position desired by him, in particular the destination floor desired by him. The call input can be effected here, in particular, by inputting by means of a corresponding input terminal or by reading out a corresponding item of information stored on a carrier medium, for example a RFID chip.

In this context, there are usually a plurality of theoretical possible ways of conveying the user from the starting position to the destination position, in particular since in principle different elevator cars can be used for conveying the user and/or different elevator shafts can be used for conveying the user. Moreover, in particular in the case of very high buildings it is possible to provide variants in which a user is not conveyed from the starting position to the destination position using just a single elevator car. In this context, in particular it is possible to provide a transfer into another elevator car. Therefore, in particular a plurality of route options or route alternatives for traveling from the starting position to the destination position result from this plurality of theoretical possibilities.

With the method proposed according to the invention, a route is determined from this plurality of route options, wherein different criteria are advantageously taken into account as the initial value for the determination of the route. In particular, a selection of the following criteria is advantageously taken into account individually or in combination: arrival time of the elevator car at the starting position, also referred to as time-to-arrival (tta); arrival time of the elevator car at the destination position, also referred to as time-to-destination (ttd); energy demand; current traffic volume; number of calls to be served; loading of the elevator car.

In particular a specification relating to the use of the at least one shaft-changing unit is advantageously taken into account as an initial value from the multiplicity of initial values for the determination of the route. In particular there is provision here that non-use of a shaft-changing unit is taken into account as a specification. That is to say therefore that in this case from the plurality of route options such a route which does not require use of a shaft-changing unit is advantageously determined. The use of a shaft-changing unit which is sometimes felt to be unpleasant by a vehicle user can be advantageously avoided in this way. In particular, in this context there is provision that the specification is issued in accordance with the user, in particular in that the user can select whether or not the route is permitted to use a shaft-changing unit of the elevator system. The specification of non-use of shaft-changing units of the elevator system for a conveying process by means of the elevator system can result here, in particular, in extension of the time to reach a destination. However, this disadvantage is surprisingly considered to be comparatively minor, and is largely accepted, by users who would like to use the shaft-changing units. In particular, the specification of non-use of shaft-changing units can have the effect that the route between the starting position and the destination position cannot be served directly by using just a single elevator car. In this case, routes which comprise, in particular, at least some travel on foot and/or the use of at least one further elevator car and/or the use of at least one travelator and/or the use of at least one escalator are advantageously determined. In this context, the determination of a route from the selection of possible routes which do not provide any use of a shaft-changing unit is advantageously continued to the effect that the fact that the route comprises as few interruptions as possible in the journey for changing between modes of transport is taken into account as a further selection criterion.

According to a further advantageous refinement there is also provision that such a specification relating to the use of a shaft-changing unit of the elevator system can be issued by a control unit of the elevator system. In this context there is particularly advantageously provision that in the event of a defect in the shaft-changing unit or maintenance of the shaft-changing unit, the use of this shaft-changing unit is avoided so that the elevator system can nevertheless continue to be operated. This advantageously further increases the availability of the elevator system.

According to a further advantageous refinement of the invention, the specification relating to the use of the at least one shaft-changing unit is determined from a plurality of selection possibilities. In particular, there is provision here that a user can activate a specification from this plurality of selection possibilities, for example by using a corresponding interface. In this context, an input terminal is preferably provided as an interface at the respective stopping points. Furthermore, in particular there is provision that the elevator user can select the specification from the selection possibilities by means of a mobile terminal, in particular by means of a smartphone, wherein a corresponding communication connection between the elevator system and the mobile terminal is advantageously set up.

In particular there is provision that the selection possibilities comprise a change prohibition. When the change prohibition is selected, only those route options for which a shaft-changing unit is not used are advantageously selected. In other words, this means that when there is a change prohibition as a specification a shaft-changing unit is not used by the at least one elevator car of the elevator system which is made available to the user for the conveying process from the starting position to the destination position. The user can therefore advantageously be sure that he travels from the starting position to the destination position without using a shaft-changing unit of the elevator system in the process. However, in particular if a shaft-changing unit is an exchanger, this does not advantageously rule out the possibility of the exchanger being traveled through. According to the present invention this means that use of a shaft-changing unit occurs only when said unit brings about a change of shaft for the elevator car, that is to say moves the elevator car from a first elevator shaft to a second elevator shaft. The specification of a change prohibition is advantageous, in particular, when, according to a basic setting, the elevator system permits the use of shaft-changing units.

According to a further advantageous refinement, the selection possibilities comprise permission to change. When the permission to change selection is made, route options are permitted in which at least one of the shaft-changing units of the elevator system is used. This means that when permission to change is specified for the route between the starting position and the destination position, changes of shaft of the elevator car, in which the user is conveyed may take place. The specification of permission to change is advantageous, in particular when, according to a basic setting, the elevator system does not permit use of a shaft-changing unit. Moreover, the provision of such a specification possibility is also advantageous, in particular, when the user of the elevator car is to be requested in all cases to activate a specification relating to the use of a shaft-changing unit. In this context, even in a basic setting of the elevator system which permits the use of shaft-changing units, the user is actively requested here to confirm actively the use of shaft-changing units once more. This makes it advantageously possible to reduce the risk of a user inadvertently accepting a route with the use of shaft-changing units contrary to his wishes.

According to a further advantageous refinement, the selection possibilities comprise change avoidance. When change avoidance is selected, at least one shaft change is carried out only if a specified further initial value cannot be complied with without a shaft change. This specification advantageously constitutes a softer criterion for the non-use of the shaft-changing unit than the change prohibition. This advantageously allows for the situation that where possible a user would like to avoid the use of a shaft-changing unit, but under certain circumstances is ready to accept the use of shaft-changing units. For this purpose, when the route is determined it is advantageously checked whether at least one further initial value can be complied with.

In particular, such a further initial value is the arrival time of an elevator car at the starting position. It is therefore provided, in particular, that a maximum time period is specified as an arrival time. If an elevator car for transporting the user which does not use a shaft-changing unit for the route cannot be made available at the starting position within this time period, instead an earlier available elevator car which utilizes at least one shaft-changing unit of the elevator system when conveying the user is advantageously used instead.

A further or alternative initial value which is taken into account here is advantageously the time to reach the destination position. For this, a maximum time period is also advantageously specified. If this time period cannot be complied with when avoiding the shaft-changing units, an elevator car which is allowed to use at least one shaft-changing unit of the elevator system is advantageously made available to service the user's call.

A further or alternative initial value which is taken into account here is advantageously barrier-free access from the starting position to the destination position. This initial value is advantageously taken into account, in particular, for conveying users with walking difficulties. If a route without the use of shaft-changing units can only be determined in such a way that, for example, an escalator or a travelator would have to be used for part of the route, instead such a route in which the user can be conveyed directly from the starting position to the destination position by means of the elevator cars of the elevator system while using as few shaft-changing units as possible is advantageously determined.

In a further advantageous refinement there is provision that in the event of non-compliance with a predefined value for an initial value from the plurality of initial values, owing to the specified change prohibition, the selection of the change prohibition is modified to a selection of change avoidance. Such a preferably automatic modification contributes here, in particular in the case of high traffic volume, to the fact that the conveying capacity of the elevator system is kept high, since in this case the routes can be optimized, in particular, to the effect that as many users as possible per unit of time can be conveyed from their starting position to their destination position. Such a modification from a change prohibition to change avoidance is preferably signaled to the elevator user. In particular, it is signaled to the elevator user if the elevator system departs from said user's specification relating to a use of the at least one shaft-changing unit.

The specified value is particularly advantageously a limiting value for traffic volume and/or a limiting value for a waiting time and/or a limiting value for a travel time and/or a limiting value for a time to reach the destination. The conveying capacity of the elevator system is advantageously increased further by complying with these limiting values individually or in combination.

In particular there is provision that the route options are also determined while taking into account at least one call which is output by the user. In this context, the activation of an external call at the starting position and the activation of an internal call in the elevator car can be provided as the outputting of a call. However, it is particularly advantageous if a destination call input is provided, and therefore that the elevator system correspondingly comprises a destination call controller. In the case of a destination call input there can advantageously be an improvement here in that users who accept the use of a shaft-changing unit are not conveyed together with users who reject the use of the shaft-changing unit. As a result, a situation is advantageously avoided in which elevator users who accept the use of a shaft-changing unit have to tolerate longer travel times until their destination position is reached owing to the avoidance of shaft-changing units, as a result of the fact that elevator users who reject the use of the shaft-changing unit have got into the elevator.

According to a further advantageous refinement of the invention, the user is requested to activate the specification relating of the at least one shaft-changing unit. In this context, the specification which is activated by the user is advantageously registered by means of a registration device which has a communication connection to the elevator system. In particular, in this context at least one terminal is provided which is made available in the region of the floor stop as a registration device. Alternatively and/or additionally, in particular a mobile terminal is provided, preferably a smartphone, which has a communication connection to the elevator system, is provided as the registration device. Through the active request to the user, the user is advantageously informed in an improved fashion about the possibility of activating a specification. In particular, according to one development of this refinement there is provision that the elevator system automatically selects a standard specification if the user does not comply with the request within a predetermined time period and does not activate a specification.

In particular there is provision that the route options comprise routes in which at least one section of the route has to be covered with a further elevator car and/or with a further passenger conveying device and/or by the user himself. This means that in particular not only routes in which a user is conveyed from the starting position to the destination position with a single elevator car can be considered as routes. Such a refinement is significant here, in particular, in the case of high buildings which comprise, for example, what are referred to as shuttle lifts and what are referred to as transfer floors.

In particular, routes which comprise at least one such section are then determined from a plurality of route options if the user has activated the speciation of a change prohibition. In particular, in this context in a first variant the user is conveyed with a first elevator car from a starting position to an intermediate position. At this intermediate position, a change of elevator car of the user is provided so that the user is conveyed from this intermediate position with a second elevator car to the destination position or to a further intermediate position. In this context, the determined route provides, in particular, that the first and second elevator car are moved in a first elevator shaft. As a refinement variant there is provision, in particular, that the first elevator car is moved in a first elevator shaft, and the second elevator car is moved in a second elevator shaft of the elevator system. In this context, the first and the second elevator shaft do not have to be arranged one next to the other in a building. In particular, routes in which the first elevator shaft and the second elevator shaft are separated from one another by a corridor, a lobby and/or by another part of the building, such as for example a plurality of offices, are also provided. According to a second variant there is, in particular, provision that the user is conveyed with one elevator car as far as an intermediate position, from which the user arrives at a further intermediate position or the destination position in some other way, in particular by using at least one staircase and/or at least one escalator.

According to a further advantageous refinement of the invention, an identity is stored in a data record for the user. The specification relating to a use of the at least one shaft-changing unit is advantageously linked to the identity, wherein before the route is determined the identity of the user is registered by means of an identity-registration unit of the elevator system. In particular there is provision here that the registration of the identity of the user is carried out together with an input of a call and/or a specification relating to the use of the at least one shaft-changing unit, in particular in that the registration unit reads out an ID card of the user. For this purpose, technology for transmitter/receiver systems for automatic and contactless identification, in particular RFID (radio-frequency identification), preferably near-field communication (NFC), is advantageously used. According to a further advantageous refinement variant, the registration of the identity of the user is carried out by means of face recognition or by means of an iris scanner, in particular for secure areas in a building.

A further advantageous refinement provides that for a user a data set with his identity, together with a specification relating to the use of the at least one shaft-changing unit, is permanently stored in a database. This data set is advantageously called in order to determine the route when the identity of the user is registered by means of the registration unit. The permanent storage of a data set with an identity of a user together with a specification relating to a use of one shaft-changing unit in a database is advantageous, in particular, when a user uses the elevator system frequently and his specification relating to the use of the at least one shaft-changing unit corresponds to a fixed selection possibility or is rarely modified. As a result, convenience of use of the elevator system is advantageously further increased.

In a further advantageous refinement, a use profile is stored for a user. In particular, in a data set the specification relating to the use of the at least one shaft-changing unit which has been activated by the user is stored in a data set together with the identity of the user. In particular, by means of the use profile it is determined how frequently a user has activated a specification from the plurality of selection possibilities in comparison with another specification from this plurality of selection possibilities.

If a data set with a user's identity together with a specification relating to the use of the at least one shaft-changing unit is not continuously stored for said user in a database, and according to his use profile a specification relating to the use of the at least one shaft-changing unit, the user advantageously receives an enquiry as to whether his identity is to be stored permanently together with the corresponding specification relating to the use of the at least one shaft-changing unit in the database.

If a data set with a user's identity is already permanently stored for the user, together with a specification relating to the use of the at least one shaft-changing unit, in a database, and according to his use profile the user prefers another specification relating to the use of the at least one shaft-changing unit as the specification which is stored together with his identity in the database, the user advantageously receives an enquiry as to whether the specification relating to the use of the at least one shaft-changing unit, which is stored together with his identity in the database, is to be overwritten with the specification relating to the use of the at least one shaft-changing unit which the user prefers according to his use profile.

In particular, the user receives the corresponding enquiry directly after an input, activated by him, of the specification relating to the use of the at least one shaft-changing unit as a display on the input terminal and/or on the mobile terminal, in particular a smartphone, with which the user had previously selected the specification from the selection possibilities. By means of a confirmation by the user, his identity is permanently stored together with the corresponding specification relating to the use of the at least one shaft-changing unit in the database. In this way, it is no longer necessary for the user to activate again a specification relating to the use of the at least one shaft-changing unit whenever the elevator system is used.

In particular, according to a further advantageous refinement, the control system which registers the user specifications is self-learning. The control system advantageously also learns here, in particular also without a user input, whether a detected user accepts the use of a shaft-changing unit or not, and advantageously sets a corresponding default value if a user input relating to the use of shaft-changing units fails to occur. According to one advantageous development of the invention, before the user is conveyed in an elevator car of the elevator system, it is checked whether the registered identity corresponds to the identity of the at least one user in the elevator car. This advantageously further reduces the probability of an elevator user entering an “incorrect” elevator car, that is to say an elevator car which stops at the starting position but is not provided to service the user's call. When such an “incorrect” elevator car is used, it could also be the case that this elevator car uses shaft-changing units even though the user would not like to use any shaft-changing units on his route. This is advantageously prevented by the identity checking. In particular there is provision that the user of the elevator car is informed if the checking of the identity before the user is conveyed reveals that the identity of at least one user of the elevator car does not correspond to the identity from the data set used for the determination of the route of this elevator car. The information as to whether the identity of the at least one user of the elevator car corresponds to the identity stored for the determination of the route in the data set is advantageously provided by means of a visual and/or acoustic signal.

In particular, when the identity corresponds, the conveying operation is executed in accordance with the determined route.

A further advantageous refinement of the invention provides that a user is informed if his activated specification or the specification linked to his identity cannot be made available; and/or his activated specification or the specification linked to his identity affects the waiting time and/or the time to reach a destination; and/or a change of elevator car is necessary at at least one intermediate position between a starting position and a destination position; and/or the identity of the at least one user of an elevator car does not correspond to the identity from the data set used for the determination of the route of this elevator car.

The fact that a specification which is activated by the user or the specification which is linked to his identity and which relates to the use of the at least one shaft-changing unit cannot be made available occurs, for example, owing to a specified change prohibition a specified value for an initial value from the plurality of initial values is not complied with and as a result the selection of the change prohibition is modified to a selection of change avoidance. By means of the information which is output to the user in this case, the user is therefore advantageously provided with the opportunity of adapting to at least one possible undesired shaft change through the use of at least one shaft-changing unit. Moreover, through the provision of the information, the elevator user is advantageously provided with the option of deciding, after the receipt of the information, which other way he would like to use to arrive at his desired destination position, in particular in that the user uses at least one staircase and/or at least one escalator. The information which is provided to the user preferably comprises an indication of such an option. This information is also advantageously output as a route description on a mobile terminal of the user. The user is also advantageously provided with a selection possibility by means of which he communicates to the elevator system if the user decides against use of the elevator system.

The user is also advantageously informed if the determined route provides a change of elevator car at at least one intermediate position. In one advantageous embodiment the user receives an indication of the at least one intermediate position, in particular with an indication of the elevator shaft in which the route is continued.

If a route which is determined by the elevator system provides that the user uses, between two intermediate positions or from one intermediate position to the destination position, at least one other transportation means, in particular at least one escalator and/or at least one travelator and/or uses at least one staircase, the user advantageously receives in this case an indication of the at least one intermediate position. The user also advantageously receives an indication as to which at least one other means of transportation is available to the user in order to arrive at the next intermediate position or at the destination position.

If the determined route provides that the route from the at least one intermediate position, at which the user has arrived using at least one other transportation means, is continued with an elevator car, the user advantageously receives an indication of the elevator shaft in which the route is continued from this intermediate position.

If the determined route provides a change of elevator car at at least one intermediate position or if the determined route provides that the route is continued with an elevator car from the at least one intermediate position to which the user has arrived using at least one other transportation means, the call of an elevator car which is moved in the elevator shaft in which the route is continued, in order to convey the user from the at least one intermediate position to the next intermediate position or to the destination position already takes place when the route is determined. It is therefore advantageously not necessary for the user to output a further call at the intermediate position. In particular, when the route is determined, the time which the user requires to arrive at the elevator shaft at the intermediate position is taken into account, so that the user does not experience any longer delays at the intermediate position.

In particular there is also provision that the user arrives at a first intermediate position from the starting position by means of at least one staircase or by means of at least one other transportation means such as, in particular, at least one escalator and/or at least one travelator and gets into an elevator car at the first intermediate position in order to continue the route. In this case, the user also advantageously receives all the information relating to the specific route which is relevant for him.

According to a further advantageous refinement, the user receives at the starting position, irrespective of which route has been determined, acoustic information relating to the determined route, in particular in the form of an announcement and/or a text message with information relating to the determined route. The information therefore preferably comprises in accordance with the determined route
data about the specification relating to the use of at least one shaft-changing unit which has been taken into account for the determination of the route, and/or
data about the number of shaft changes for which at least one shaft-changing unit is used, and/or
an indication of the at least one intermediate position, and/or
an indication of the elevator shaft in which the route is continued from the at least one intermediate position, and/or
an indication as to whether the route comprises at least one staircase and/or at least one other transportation means such as, in particular, at least one travelator and/or at least one escalator.

The information relating to the determined route to the user as a text message is communicated, in particular, by SMS (short message service), email or short message service. In this way, the user preferably receives the information corresponding to the determined route on a mobile terminal, in particular a smartphone or a tablet PC.

The elevator system which is also proposed for the solution of the problem specified above comprises a plurality of elevator shafts, at least one elevator car and at least one shaft-changing unit. In this context, the at least one elevator car can be changed over by means of the at least one shaft-changing unit from a first elevator shaft of the elevator system into a second elevator shaft of the elevator system. The elevator system is designed here to carry out a method as described above, in particular also a method which results from combinations of the different refinements. For this purpose there is, in particular, provision that the elevator system comprises a control system which controls the necessary method steps. The control system can be embodied here as a central control system or as a decentralized control system. In particular, at least part of the control system is designed to determine the route. For the execution of the proposed method or of the proposed method variants, in particular configurations of the elevator system are provided in which the elevator system comprises a destination call controller and/or registration units such as terminals and/or RFID readers and/or identification registration devices and/or information output devices.

Further advantageous details, features and configuration details of the invention are explained in more detail in conjunction with the exemplary embodiments illustrated in the figures, of which:

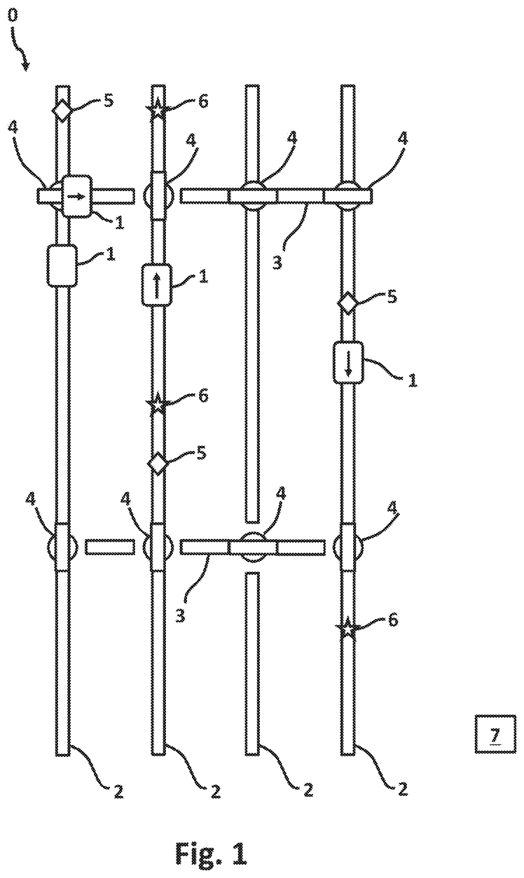

FIG. 1 shows a simplified schematic illustration of an exemplary embodiment of an elevator system according to the invention;

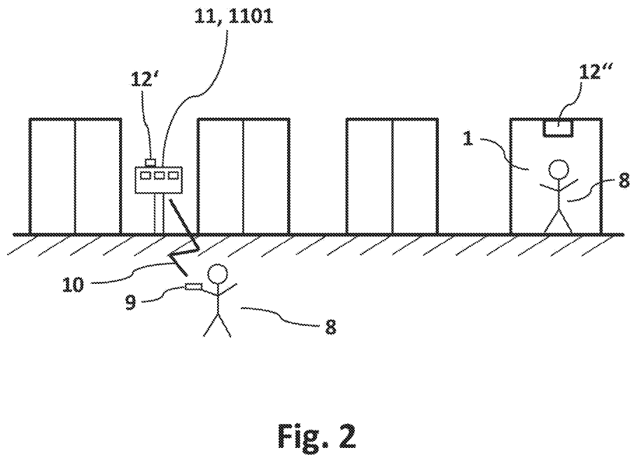

FIG. 2 shows a simplified schematic illustration of an exemplary embodiment of the configuration of a registration device for registering a specification relating to the use of shaft-changing units and for the configuration of an identification registration device;

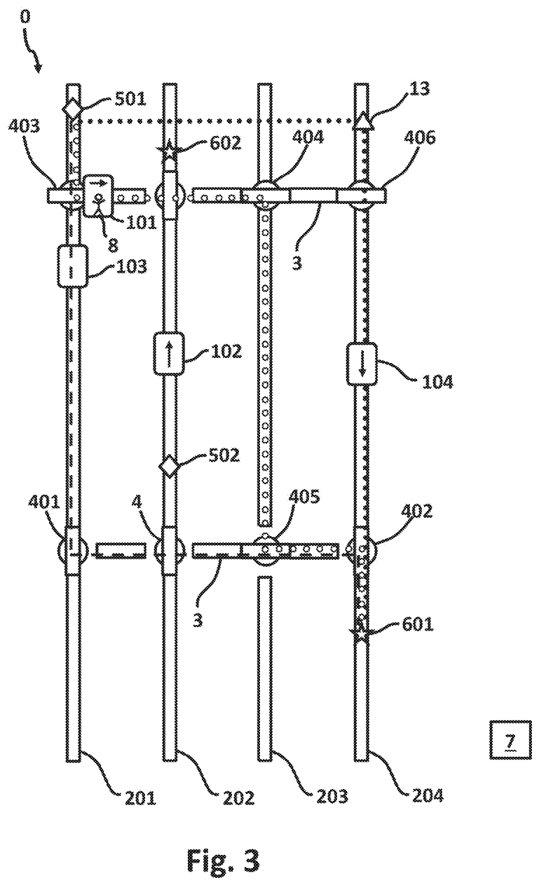

FIG. 3 shows a simplified schematic illustration of examples of specific routes for conveying a user from a starting position to a destination position in an exemplary embodiment of an elevator system according to the invention; and

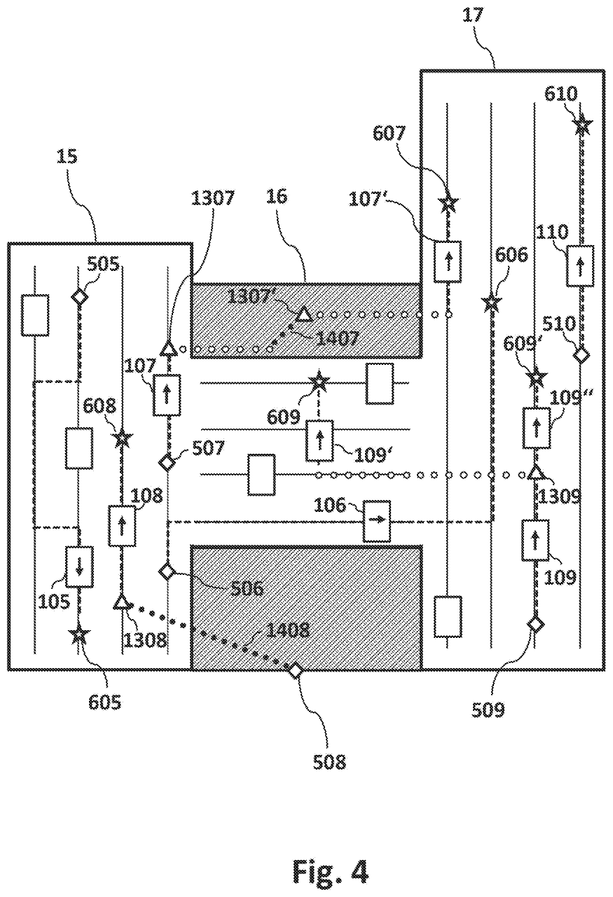

FIG. 4 shows a schematic illustration of examples of determined routes for conveying a user from a starting position to a destination position in an exemplary embodiment of an elevator system according to the invention.

### LIST OF REFERENCE NUMBERS

0 Elevator system
1 Elevator car
101 Elevator car
102 Elevator car
103 Elevator car
104 Elevator car
105 Elevator car
106 Elevator car
107 Elevator car
108 Elevator car
109 Elevator car
110 Elevator car
2 Vertical guide rail/elevator shaft
201 Vertical guide rail/elevator shaft
202 Vertical guide rail/elevator shaft
203 Vertical guide rail/elevator shaft
204 Vertical guide rail/elevator shaft
3 Horizontal guide rail
4 Shaft-changing unit
401 Shaft-changing unit
402 Shaft-changing unit
403 Shaft-changing unit
404 Shaft-changing unit
405 Shaft-changing unit
406 Shaft-changing unit
5 Starting position
501 Starting position
502 Starting position
505 Starting position
506 Starting position
507 Starting position
508 Starting position
509 Starting position
510 Starting position
6 Destination position
601 Destination position
602 Destination position
605 Destination position
606 Destination position
607 Destination position
608 Destination position
609 Destination position
610 Destination position
7 Control system
8 User
9 Mobile terminal
10 Communication connection
11 Registration device
1101 Terminal
12 Identification registration device
13 Intermediate position
1307 Intermediate position
1308 Intermediate position
1309 Intermediate position
14 Staircase/passenger conveying device
1407 Staircase/passenger conveying device
1408 Staircase/passenger conveying device
15 First part of a building
16 Intermediate building
17 Second part of a building

FIG. 1 shows a simplified illustration of an elevator system 0 with a plurality of elevator shafts, defined by the vertical guide rails 2 in which a plurality of elevator cars 1 are moved individually, that is to say essentially independently of one another, by means of a linear motor drive.

The elevator system 0 comprises vertically oriented elevator shafts in which the elevator cars 1 are moved vertically along guide rails 2, as well as horizontally oriented elevator shafts in which the elevator cars 1 are moved horizontally along guide rails 3.

In a further embodiment (not illustrated), the elevator system 0 can also comprise diagonally oriented elevator shafts in which the elevator cars 1 are moved obliquely. Furthermore, the elevator system 0 comprises shaft-changing units 4, which are embodied as rotatably mounted rail elements, referred to as exchangers. By means of a shaft-changing unit 4 the direction of travel of an elevator car 1 changes from the vertical into the horizontal or vice versa. Furthermore, by using shaft-changing units 4 it is possible to change over an elevator car 1 from a first elevator shaft into a second elevator shaft.

Owing to the possibility of changes of shaft using shaft-changing units 4 a plurality of route options are obtained for conveying a user of the elevator system 0 from a starting position 5 to a destination position 6.

A route is determined from this plurality of route options by means of a control system 7 and taking into account a plurality of initial values for the conveying of a user. When the route is determined, the following criteria are taken into account: arrival time of the elevator car 1 at the starting position 5, also referred to as time-to-arrival (tta); arrival time of the elevator car 1 at the destination position 6, also referred to as time-to-destination (ttd); energy demand; current traffic volume; number of calls to be serviced; loading of the elevator car 1. In particular, when the elevator car is determined a specification relating to the use of shaft-changing units 4 is taken into account as an initial value from the plurality of output values. The specification relating to the use of at least one shaft-changing unit 4 of the elevator system is determined here from a plurality of selection possibilities, wherein in this exemplary embodiment there is provision that the user activates the specification relating to the use of shaft-changing units 4 from this plurality of selection possibilities. That is to say the user selects whether the use of a shaft-changing unit 4 of the elevator system is permitted for the route or not.

The selection possibilities comprise a change prohibition, wherein when the change prohibition is selected only those route options for which a shaft-changing unit 4 is not used are permitted.

Furthermore, the selection possibilities comprise change permission, wherein when the change permission is selected route options are permitted for which at least one of the shaft-changing units 4 of the elevator system 0 is used. This means that when change permission for the route between the starting position 5 and the destination position 6 is specified shaft changes of the elevator car in which the user is transported may take place.

In this exemplary embodiment, the selection possibilities also comprise change avoidance. When change avoidance is selected, at least one shaft change is carried out only if a specified further initial value, for example a specified maximum time period for the time-to-time destination, cannot be complied with without a shaft change.

In a special operating mode of the elevator system 0, for example in the case of maintenance work on the shaft-changing units, the specification relating to the use of a shaft-changing unit 4 of the elevator system 0 can also be performed directly by a control unit 7 of the elevator system 0. If, for example, a defect of the shaft-changing unit 4 occurs or if the shaft-changing unit 4 is being maintained, the control unit 7 issues a specification relating to the use of a shaft-changing unit 4 so that the use of the shaft-changing unit 4 which is defective or is undergoing maintenance is avoided.

Furthermore, the controller of the elevator system 0 shown by way of example in FIG. 1 can be configured, in particular by elevator maintenance personnel, in such a way that a selection of the change prohibition activated by the user can be modified by the control unit 7 of the elevator system 0 into a selection of change avoidance if noncompliance with a predefined value for an initial value from the plurality of initial values is caused by the specified change prohibition.

In this exemplary embodiment, a limiting value for a traffic volume, a limiting value for a waiting time, a limiting value for a travel time and a limiting value for a time to reach a destination are provided as specified values. Complying with these limiting values increases the conveying capacity of the elevator system 0 further.

In addition to the specification, activated by a user, relating to the use of shaft-changing units 4, a call which is output by the user is taken into account during the determination of the travel options. In this context, there can be provision that an external call is activated at the starting position 5 and an internal call is activated in the elevator car 1 as call output. In this exemplary embodiment, a destination call input outside the elevator car 1 is provided. By taking into account destination call input, control is carried out to the effect that users who accept the use of a shaft-changing unit 4 are not conveyed together with users who reject the use of a shaft-changing unit 4. This avoids a situation in which elevator users who accept the use of a shaft-changing unit 4 have to tolerate longer travel times until the destination position 6 is reached owing to the avoidance of shaft-changing units 4 as a result of new elevator users, who reject the use of a shaft-changing unit 4, getting into the elevator.

FIG. 2 is a schematic illustration of the elevator system shown in FIG. 1 in an exemplary embodiment for the activation of a specification relating to the use of the at least one shaft-changing unit 4 from a plurality of selection possibilities by a user 8.

Before the determination of the route for conveying the user 8 from a starting position 5 to a destination position 6, the user 8 is requested to activate a specification relating to a use of the at least one shaft-changing unit 4, wherein the user can select the specification from a plurality of selection possibilities.

The specification which is activated by the user 8 is registered in this exemplary embodiment by means of a detection device 11 which has a communication connection 10 to the elevator system. In this exemplary embodiment here a terminal 1101 which is made available in the region of the floor stops, in particular in the elevator lobby, is provided as a registration device 11. Alternatively or additionally, in particular a mobile terminal 9, preferably a smartphone which has a communication connection 10 to the elevator system, is provided as a registration device 11.

Through the selection of change prohibition, the user 8 specifies to the control system 7, during the determination of the route for transporting the user 8 from the starting position 5 to a destination position 6, as illustrated in FIG. 1 only those route options for which a shaft-changing unit 4 is not used, that is to say for which no shaft change takes place by means of a shaft-changing unit 4. In this way, the user 8 can advantageously be certain that he will arrive at the destination position 6 from the starting position 5 without a shaft-changing unit 4 of the elevator system being used in the process. However, this does not rule out the possibility that if a shaft-changing unit 4 is an exchanger, the exchanger is traveled through. This is because travel through the exchanger without the exchanger becoming active does not constitute use of a shaft-changing unit according to the present invention. The specification of change prohibition is provided, in particular, when the elevator system 0 permits the use of shaft-changing units 4 according to a basic setting.

In contrast, through the selection of change permission the user 8 allows route options for which at least one shaft-changing unit 4 is used to be permitted during the determination of the route for conveying the user 8 from a starting position 5 to a destination position 6. That is to say shaft changes are allowed to take place during the specification of the change permission for the elevator car 1 in which the user 8 is conveyed. The specification of change permission is advantageous, in particular, when according to a basic setting the elevator system 0 does not permit the use of a shaft-changing unit 4. In this case, where appropriate, route options for which the arrival time of the elevator car 1 at the destination position 6, also referred to as time-to-destination (ttd), has a lower value compared with the route options for which a shaft change is not permitted, can be determined by the selection of change permission.

Through the selection of change avoidance the user 8 specifies that where possible he would like to avoid the use of a shaft-changing unit 4, but under certain circumstances is ready to accept the use of shaft-changing units 4. During the determination of the route it is advantageously checked whether a further initial value can be complied with by non-use of shaft changes by means of at least one shaft-changing unit 4. Advantageously, when change avoidance is selected at least one shaft change is carried out only when a specified further initial value, such as for example a limiting value for a travel time, cannot be complied with without a shaft change.

If the user 8 does not activate a specification on request within a predetermined time period, the control unit 7 of the elevator system 0 automatically selects in this exemplary embodiment a standard specification relating to the use of at least one shaft-changing unit 4.

According to the specification relating to the use of shaft-changing units 4, and according to further specified values such as for example the specification of a limiting value for a traffic volume and/or for a waiting time and/or for a travel time and/or for a time to reach a destination and taking into account at least one call which is output by the user 8, a route for conveying the user 8 is determined from a plurality of route options by means of the control system 7.

A determined route can provide continuous conveying of the user 8 from a starting position 5 to a destination position 6, for which a shaft change does not take place or at least one shaft change takes place using shaft-changing units 4. However, during such a continuous conveying process, the user 8 must not change the elevator car 1 but rather the conveying process is carried out by means of the one elevator car 1 from the starting position 5 as far as the destination position 6. It is likewise possible for a route for a non-continuous conveying process to have at least one intermediate position 13 between the starting position 5 and the destination position 6, wherein at least one section of the route has to be traveled along with a further elevator car 1 and/or with a further passenger conveying device 14, such as in particular at least one escalator and/or at least one travelator and/or by the user 8 himself.

Before the route is determined, the identity of the user 8 is registered by means of an identity registration unit 12′, shown by way of example in FIG. 2, of the elevator system 0. The registration device 11 which has a communication connection 10 to the elevator system 0 advantageously comprises an identity registration unit 12′ so that the registration of the identity of the user 8 can be carried out together with the inputting of a call and a specification relating to the use of shaft-changing units 4. In this context, a terminal 1101 which is made available in the region of the floor stops is provided in FIG. 2 as a registration device 11. The user 8 can optionally also use a mobile terminal 9, preferably a smartphone, which is designed for this purpose and has a communication connection 10 to the elevator system 0.

The identity registration unit 12′ registers in this exemplary embodiment the identity of the user 8 by the registration unit 11 reading out an ID card of the user 8. For this purpose, technology for transmitter/receiver systems for automatic and contactless identification is used, for example RFID (radio-frequency identification) or nearfield communication (NFC). In one configuration variant, not illustrated in FIG. 2, the registration of the identity of the user 8 is carried out by means of facial recognition or by means of an iris scanner, in particular for secure areas in a building.

The identity of the user 8 which is determined by means of the identity registration unit 12′ is stored in a data set, and the specification relating to a use of the at least one shaft-changing unit 4 is linked to the identity of the user 8.

For this purpose, in this exemplary embodiment a data set with the identity of a user 8 is permanently stored for said user 8 together with a specification relating to the use of the at least one shaft-changing unit 4 in a database. In order to determine the route, this data set is called during the registration of the identity of the user 8 by means of the registration unit 11. The permanent storage of a data set with the identity of a user 8 together with a specification relating to a use of the at least one shaft-changing unit 4 in a database is advantageous, in particular, when a user 8 uses the elevator system 0 frequently and his specification relating to the use of the at least one-shaft changing unit 4 corresponds to a fixed selection possibility or is modified only rarely.

The user 8 receives at the starting position 5, irrespective of which route has been determined, acoustic information relating to the determined route, in particular in the form of an announcement and/or a text message with information relating to the determined route. Communication of the information relating to the determined route to the user 8 as a text message is carried out, in particular, by SMS (short message service), email or short message service. In this way, the user 8 receives the information corresponding to the determined route preferably on a mobile terminal 9, in particular a smartphone or a tablet PC. In this context, the information relating to the determined route is preferably output as a route description.

In this exemplary embodiment the information corresponding to the determined route comprises data about the specification relating to the use of at least one shaft-changing unit 4 which has been taken into account for the determination of the route. If a specification which is activated by the user 8 or the specification which is linked to his identity cannot be made available or if his activated specification or the specification linked to his identity affects the waiting time or the time to reach a destination, the user 8 is informed of this. The case in which a specification which is activated by the user 8 or the specification which is linked to his identity and relates to the use of the at least one shaft-changing unit 4 cannot be made available occurs, for example, if noncompliance with a specified value for an initial value from the plurality of initial values occurs owing to a specified change prohibition, and as a result the selection of the change prohibition is modified to selection of change avoidance. By means of the information which is output to the user 8 in this case, the user 8 is therefore provided with the opportunity of adapting to at least one possible undesired shaft change by using at least one shaft-changing unit 4. Moreover, through the provision of the information the elevator user 8 is provided with the option of deciding, after reception of the information, to arrive at his desired destination position 6 in some other way, in particular by the user 8 using at least one staircase and/or at least one further passenger conveying device 14, such as for example as escalator. The information which is provided to the user 8 advantageously comprises an indication of such an option. The user 8 is also offered a selection possibility by means of which it is communicated to the elevator system 0 if the user 8 decides against use of the elevator system 0.

If a route which is determined for the conveying of a user 8 provides at least one shaft change, the user 8 receives information about the number of shaft changes for which at least one shaft-changing unit 4 is used. In this way, the user 8 can adapt in advance to the at least one shaft change using shaft-changing units 4.

Under certain circumstances, the determined route for conveying the user 8 from a starting position 5 to a destination position 6 provides at least one intermediate position 13. In this case, the user 8 receives an indication of the at least one intermediate position 13.

According to the determined route, the user 8 arrives at the at least one intermediate position 13 either with a first elevator car 1, a further passenger conveying device 14, such as for example an escalator or a travelator, or on foot, for example using a staircase. Likewise, the determined route can provide that the user 8 continues his route from the intermediate position 13 with a second elevator car 1, a further passenger conveying device 14, or on foot.

If a change of elevator car is necessary at the at least one intermediate position 13, the user 8 receives indication of the elevator shaft in which the route is continued from the at least one intermediate position 13.

If a determined route provides that the user 8 uses at least one other transportation means 14 between the starting position 5 and an intermediate position 13 and/or between two intermediate positions 13 and/or from an intermediate position 13 to the destination position 6, in particular at least one escalator and/or at least one travelator and/or at least one staircase, the user 8 advantageously receives in this case an indication of the at least one intermediate position 13 and by this means an indication of which at least one other transportation means 14 is respectively available to the user 8 in order to arrive at the next intermediate position 13 or at the destination position 6.

If the determined route provides that the route is continued with an elevator car 1 from the at least one intermediate position 13 at which the user 8 has arrived by means of at least one other transportation means 14, the user 8 advantageously receives an indication of the elevator shaft in which the route is continued from this intermediate position 13.

Before the user 8 is conveyed with an elevator car 1 of the elevator system 0, it is checked in the elevator car 1 by means of an identity registration unit 12″ located in the elevator car 1 whether the registered identity corresponds to the identity of the at least one user 8 in the elevator car 1. It is possible here that the identity registration unit 12′ which registers the identity of the user 8 before the route is determined and the identity registration unit 12″ which is mounted in the elevator car 1 determine the identity of the user 8 in different ways.

If the identity of the at least one user 8 in the elevator car 1 corresponds to the identity from the data set used for the determination of the route of this elevator car 1, the conveying of the user 8 is carried out in accordance with the determined route. When the identity of the at least one user 8 in the elevator car does not correspond to the identity from the data set used for the determination of the route of this elevator car 1, the user 8 of the elevator car 1 is informed about this. The information as to whether the identity of the at least one user 8 of the elevator car 1 corresponds to the identity stored for the determination of the route in the data set is advantageously provided by means of a visual and/or acoustic signal.

The checking as to whether the registered identity corresponds to the identity of the at least one user 8 in the elevator car 1 advantageously reduces the probability of an elevator user 8 getting into an “incorrect” elevator car 1, that is to say an elevator car 1 which also stops at the starting position 5 but is not provided to service the call of the user 8.

FIG. 3 shows a selection of route options for the conveying of a user 8 from a starting position 501 to a destination position 601 using the elevator system 0, which options are illustrated in FIG. 3 by dashes, by circles and by dots. From these route options, the route for conveying a user 8 from the starting position 501 to the destination position 601 using the elevator system 0 is determined by means of the control system 7.

Taking into account the fact that according to one specification of the control system 7 the value for the arrival time at the destination position 601, also referred to as time-to-destination (ttd), is to be as minimal as possible, in this exemplary embodiment the route illustrated by dashed lines for conveying the user 8 from the starting position 501 to the destination position 601 would be a theoretical option in which the user 8 could be conveyed from the starting position 501 with the elevator car 101 using the shaft-changing units 401 and 402. In contrast, the shaft-changing unit 403 would merely be passed through and would not be active for the conveying of the user 8 from the starting position 501 to the destination position 601. That is to say no use of the shaft-changing unit 403 according to the invention would occur.

However, in the example illustrated in FIG. 3 the elevator car 103, which is moved along the vertical guide rail 201, is in a stopping position. At the same time, the elevator car 102 is moved along the vertical guide rail 202 from the starting position 502 to the destination position 602. In order to avoid a collision with one of the elevator cars 103 and 102 while taking into account the velocity of the elevator car 102 and taking into account a call assigned to the elevator car 103, the route option which is illustrated with circles, and for which the shaft-changing units 403, 404, 405 and 402 are used, is therefore determined as the route for conveying the user 8 from the starting position 501 to the destination position 601 if change permission has been specified to the control system 7.

If, on the other hand, the user 8 activates the specification of a change prohibition, the control system 7 determines the route option illustrated by dots in FIG. 3 as the route, from the route options for conveying the user 8 from the starting position 501 to the destination position 601. In this context, the user 8 initially arrives at an intermediate position 13 on foot or by means of a further passenger conveying device which is not explicitly illustrated in FIG. 3, such as for example by means of a travelator. In this exemplary embodiment, the user 8 is conveyed continuously from the intermediate position 13 to the destination position 601 along the vertical guide rail 204 by means of the elevator car 104 without using shaft-changing units of the elevator system 0. In this context, the elevator car 104 passes through the shaft-changing units 406 and 402 without the shaft-changing units 406 and 402 with the elevator car 104 located therein becoming active so that no use of either of the shaft-changing units 406, 402 according to the invention for the conveying process takes place.

FIG. 4 shows a schematic illustration of various possible routes for conveying a user 8 from a starting position 5 to a destination position 6 by means of an elevator system 0 which comprises a plurality of elevator shafts in which at least one elevator car 1 can be moved along vertical guide rails 2 and horizontal guide rails 3 and can be changed from a first elevator shaft into a second elevator shaft by means of at least one shaft-changing unit 4.

The routes illustrated in FIG. 4 have sections and sub-sections which are traveled along with an elevator car 1, subsections illustrated by circles within a floor, which are traveled along by the user 8 on foot and/or by means of a further passenger conveying device 14, such as for example a travelator, as well as sub-sections which are illustrated by dots, involve a change of floor and are traveled along by the user 8 by means of a staircase and/or a further passenger conveying device 14 such as, for example, a staircase and/or travelator.

A route which is determined for conveying a user 8 from a starting position 5 to a destination position 6 can be provided by a continuous conveying process of the user 8, during which the user 8 is conveyed continuously in an elevator car 1 from the starting position 5 to the destination position 6. In this context, the elevator car 1 can be moved directly, without a shaft change, within a first elevator shaft, such as for example within the route from the starting position 510 to the destination position 610 by means of the elevator car 110.

Likewise, a route can provide a continuous conveying process of a user 8 with at least one shaft change by means of at least one shaft-changing unit 4, during which the elevator car 1 is changed from a first elevator shaft into a second elevator shaft. In the illustrated example, the elevator car 105 is moved from the starting position 505 to the destination position 605, wherein the elevator car 105 is changed, by means of shaft-changing units 4, from a first elevator shaft into a second elevator shaft, and on the further route is changed back into the first elevator shaft. In a further example, an elevator car 106 is changed, by means of shaft-changing units 4, from a first elevator shaft to a second elevator shaft, wherein the elevator car 106 is moved from the starting position 506 in a first part 15 of a building to the destination position 606 in a second part 17 of the building, and wherein the elevator car 106 passes through an intermediate building 16 of the building. By means of the shaft-changing units 4, the direction of travel of the elevator car 106 is changed from a vertical direction of travel into a horizontal direction of travel, and subsequently after the intermediate building 16 is passed through there is change over from the horizontal direction of travel back into a vertical direction of travel.

A route which is determined for conveying a user 8 from a starting position 5 to a destination position 6 can, however, also have at least one intermediate position 13.

For example, a determined route for conveying the user 8 from a starting position 508 to a destination position 608 provides that the user 8 travels from the starting position 508, firstly by means of a staircase and/or a further passenger conveying device 14 such as, for example, an escalator and/or a travelator, to an intermediate position 1038 at which the user 8 changes into an elevator car 108 with which he is conveyed to the destination position 608.

In a further example, the route which is determined for conveying the user 8 provides a change of elevator car at an intermediate position 13, that is to say the user is conveyed from a starting position 509 with a first elevator car 109 to an intermediate position 1309 at which the user 8 gets into a second elevator car 109′ or 109″ in which the route is continued as far as the destination position 609 or 609′. In the illustrated example, the first elevator car 109 is moved in a first elevator shaft, and the second elevator car 109′ is moved in a second elevator shaft, wherein the first and the second elevator shafts are spatially separated from one another, for example by a corridor, so that the user 8 has to travel a certain distance on foot and/or with a travelator in order to change between elevator cars. Likewise, it is, however, possible, for the route to provide that the first elevator car 109 and the second elevator car 109″ into which the user changes at the intermediate station 1039 in order to travel to the destination position 609′ are moved in the same elevator shaft so that a shaft change is not necessary.

Furthermore, FIG. 4 illustrates by way of example a route from the starting position 507 to the destination position 607, which route comprises a plurality of intermediate positions 13. In this context, the user 8 is conveyed from the starting position 507 with the first elevator car 107 to the first intermediate position 1307. By means of a staircase and/or a further passenger conveying device 1407 the user 8 travels to the second intermediate position 1307′ from which the user 8 is conveyed with the second elevator car 107′ to the destination position 607. In this context, owing to the spatial separation of the respective elevator shaft from the staircase and/or further passenger conveying device 1407 the determined route provides a walkway and/or a use of at least one travelator.

1.-15. (canceled)

16. A method for operating an elevator system that includes a first elevator shaft, a second elevator shaft, an elevator car, and a shaft-changing unit, wherein the elevator car is configured to change from the first elevator shaft to the second elevator shaft by way of the shaft-changing unit, the method comprising:
determining a route from a plurality of route options to convey a user of the elevator system from a starting position to a destination position, wherein determining the route comprises taking into account a plurality of initial values, wherein determining the route comprises taking into account a specification relating to a use of the shaft-changing unit as an initial value from the plurality of initial values.

17. The method of claim 16 wherein the specification is determined from a plurality of selection possibilities.

18. The method of claim 17 wherein the plurality of selection possibilities comprise a change prohibition, wherein when the change prohibition is selected only those route options that do not use the shaft-changing unit are permitted.

19. The method of claim 17 wherein the plurality of selection possibilities comprise permission to change, wherein when the permission to change is selected those route options that use the shaft-changing unit are permitted.

20. The method of claim 17 wherein the plurality of selection possibilities comprise change avoidance, wherein when the change avoidance is selected a shaft change is performed only when a specified further initial value cannot be complied with without the shaft change.

21. The method of claim 17 wherein the plurality of selection possibilities comprise a change prohibition, wherein when the change prohibition is selected only those route options that do not use the shaft-changing unit are permitted, wherein the plurality of selection possibilities comprise change avoidance, wherein when the change avoidance is selected a shaft change is performed only when a specified further initial value cannot be complied with without the shaft change, wherein in an event of non-compliance with a predefined value for an initial value of the plurality of initial values owing to the change prohibition, the selection of the change prohibition is modified to the selection of change avoidance.

22. The method of claim 21 wherein the predefined value is at least one of a limiting value for traffic volume, a waiting time, a travel time, or a time to reach a destination.

23. The method of claim 16 wherein determining the route from the plurality of route options comprises taking into account a call that is output by the user.

24. The method of claim 16 comprising:
requesting the user to activate the specification; and
registering the specification activated by the user by way of a registering device that has a communication connection to the elevator system.

25. The method of claim 16 wherein the elevator car is a first elevator car, wherein the plurality of route options comprise at least one of:
routes that require travel by the first elevator car and a second elevator car;
routes that require travel via a passenger conveying system in addition to the elevator system; or
routes that require travel by the user.

26. The method of claim 16 comprising:
storing an identity of the user in a data set;
linking the specification to the identity; and
registering the identity of the user by way of an identity-registering unit of the elevator system before determining the route.

27. The method of claim 26 wherein before the user is conveyed in the elevator car, the method comprises checking whether the registered identity corresponds to the identity of the user in the elevator car.

28. The method of claim 27 comprising conveying the user in accordance with the determined route when the registered identity corresponds to the identity of the user in the elevator car.

29. The method of claim 16 comprising notifying the user that at least one of
the specification activated by the user or the specification linked to an identity of the user cannot be made available;
the specification activated by the user or the specification linked to the identity of the user affects a waiting time and/or a time to reach the destination position;
a change from the elevator car to a second elevator car is necessary at an intermediate position between the starting position and the destination position; or
the identity of the user of the elevator car does not correspond to an identity from a data set used to determine the route of the elevator car.

30. An elevator system comprising:
a first elevator shaft;
a second elevator shaft;
an elevator car;
a shaft-changing unit, wherein the elevator car is configured to change from the first elevator shaft to the second elevator shaft; and
a controller configured to determine a route from a plurality of route options to convey a user of the elevator system from a starting position to a destination position, wherein to determine the route the controller takes into account a plurality of initial values, wherein to determine the route the controller takes into account a specification relating to a use of the shaft-changing unit as an initial value from the plurality of initial values.
